(19) United States
(12) Patent Application Publication
(10) Pub. No.: US 2009/0222406 A1
(43) Pub. Date: Sep. 3, 2009

(54) Method for indexing, searching and retrieving patient information from a picture archive and communications system

(76) Inventors: Alan C. Allred, Dallas, TX (US); Kyle W. Bolin, Flower Mound, TX (US)

Correspondence Address: Myers Wilson P.C., 16660 Dallas Parkway, Suite 2500, Dallas, TX, 75248, US

(21) Appl. No.: 12/394,364

(22) Filed: Feb. 27, 2009

Related U.S. Application Data
(60) Provisional application No. 61/067,413, filed on Feb. 29, 2008.

(51) Int. Cl. G06F 17/30; G06Q 50/00; G06F 17/40

(52) U.S. Cl. 707/2; 705/3; 707/E17.014; 707/E17.004; 707/E17.019

(57) ABSTRACT

The present invention is a centrally deployed, computer-based system for uniquely indexing and searching a picture archiving and communications system (PACS) or other like device. This system and method uses a LAN, WAN or global communication system, e.g., the Internet, to acquire, analyze, index, search and retrieve medically relevant facts about all patients requested by the user interacting with a PACS system. The central deployed, computer-based system of the present invention has various components that will i) increase the efficiency of a users ability to find health care related data while also improving the quality of care to individual patients; and ii) solves the problem associated with relative inaccessibility caused by storing large amounts of data on patients with various diseases within a PACS, a clear weakness of the current picture archiving and communications systems.

### CROSS-REFERENCE TO RELATED APPLICATIONS

Provisional Application: U.S. Patent Application No. 61/067,413 filed Feb. 29, 2008, and entitled “Clinical Data Navigation Software.”

### TECHNICAL FIELD

The present invention is generally a system and method of indexing, searching and retrieving patient information from a picture archive and communications systems, such as a Philips Healthcare PACS device.

### BACKGROUND

Typically, a Picture Archiving and Communication Systems (PACS) network consists of a central server that stores a database containing various patient information, patient medical records, physician records and comments associated with each patient, and associated medical images such as radiological scans (Xrays), Computer Tomography (CT) Scans, etc., all connected to one or more clients via a Local Area Network (LAN) or a Wide Area Network (WAN) which provides or utilize the information, records and images. More and more PACS include web-based interfaces to utilize the Internet as their means of communication, usually via Virtual Private Network (VPN) or Secure Sockets Layer (SSL).

Client workstations can use local peripherals for scanning image films into the system, printing image films from the system and interactive display of digital images. PACS workstations offer means of manipulating the images (crop, rotate, zoom, brightness, contrast and others). Modern radiology equipment and modalities feed patient images directly to the PACS in digital form. For backwards compatibility, most hospital imaging departments and radiology practices employ a film digitizer. Further, the deployment of Picture Archiving and Communication Systems (PACS) in radiology is changing the way imaging services are provided. The indexing, searching and retrieving of PACS related medical information is a growing challenge for Physicians, Radiology Administrators, Radiologists and Radiology Technologists.

For instance, radiology reports contain a great deal of information that characterizes a patient's medical condition. This information is largely is unstructured, taking the form of free text, and is therefore difficult to search, sort, analyze, and summarized a meaningful fashion.

The problem with the current PACS systems are that users are currently unable to target, locate and retrieve qualified search operations results in an efficient and timely manner. Presently, users rely on sophisticated query creation, and a highly customized/structured environment, to locate and deliver qualified results from a PACS system. It is not uncommon to encounter a query failure due to the constraints of the indigenous PACS search models. Further, the time required for an individual to design and create a custom query to access PACS stored information is unwieldy and often does not result in the location of the requisite patient or physician data sought by the user. The current PACS systems are designed such that a user can retrieve medical related summaries and notes of an image, but it cannot derive the image from the summaries and notes alone. Among other things, the present invention solves this limitation.

FIG. 1 represents the indigenous PACS search models. A user is promoted via structured queries to search a PACS database. See FIG. 1a. The PACS database is then queried based on the user's structured input, see FIG. 1b; a query result is returned, see FIG. 1c; and that result is outputted is some fashion either to the screen or to another output device such as a printer, see FIG. 1d. FIG. 8 is a picture of a traditional PACS system where the structured queries are identified in the following columns: Patient Name, MRN, Exam Date, and Patient Location, etc. In the traditional PACS system, searches are only successful if you know the Patient Name, MRN, Exam Date, or other patient specific information.

FIG. 2 represents the present invention, a dramatic improvement over the existing search model. FIG. 6 represents what is known as the “Crawler Index Engine”; FIG. 7 represents what is known as the “Waypoint Search Engine”. FIG. 9 through FIG. 13 are screen images of the Waypoint Search Engine user interface.

### SUMMARY

The present invention enables users to find patient information, patient medical records, physician records, summaries and notes associated with each patient, and associated medical images in an interrelated, but unstructured, fashion. It does not rely on the use of predefined queries or any other stored database procedure for locating relevant physician-patient data. Nor does it require a user to develop or know any intricate query language, or the Patient Name, MRN, Exam Date, or other patient specific information required by a traditional PACS system.

The present invention is centrally deployed, computer-based system and method that may be coupled with a PACS system or other like device. This system and method of the present invention uses a TCPIP based local area network (LAN), wide area network (WAN) or the Internet, to acquire, analyze, index, search and retrieve all medically relevant facts about PACS patients based on a free-form text or metadata search by the user. The centrally deployed, computer-based system of the present invention has various features that will increase the efficiency of a users ability to find health care related data while also improving the quality of care to individual patients. Users may be physicians, nurses, medical students, researches and administrations accessing patient related information. Users access the system through the Waypoint Search Engine, as shown in FIG. 9 through FIG. 13. The index used by the Waypoint Search Engine is derived from indigenous PACS database using the Crawler Index Engine, described more fully below.

The system and method of the present invention relieves users of having to memorize complex queries or otherwise be trained in a structured query language. The present invention provides for the efficient flow of clinically relevant information of unstructured medical nomenclature through the use of ontological paradigms including, stemming, proximity discrimination, Boolean operations, relevance weighting, fuzzy logic, and other user defined search criteria based on indigenous data and metadata provided by a PACS. FIG. 8 shows the predefined user criteria used to search of an indigenous PACS database; FIGS. 9 through 13 shows the Waypoint Search Engine user interface.

The present invention provides a system and method that has the capability to interrelate the physician provided detailed notes with the medical imaging associate with each patient. For instance, a search for 45 year old males wherein the doctor's notes referenced “cardiomyopathy,” may return a search of ten individuals. The present invention would then allow the users to access individual CT-Scans associated with each patient, if available. As such, users are able to rapidly see patient medical cases which may be similar to the patients they are currently treating thereby assisting these users in rapidly diagnosing or treating patients. A further example is shown by FIG. 10 wherein the user enters “radiologist” as non-standard search term and the Waypoint Search Engine returns a list of records from the index amassed by the Crawler Index Engine. The user may incrementally add or delete words to enhance his or her search. FIG. 11 shows the additional word “bone” added thereby further refining the search. A user may then select within the text additional words to further refine the search. See FIG. 12, wherein it states “Right Click on metacarpal to access the menu.” The term “metacarpal” will then be added to the search criteria forming either of the following searches: “radiologist and bone and metacarpal” or “radiologist and bone or metacarpal”. See FIG. 13. Sample medical image outputs associated with the search criteria and linked from the Crawler Index Engine derived index to the native PACS system data center are shown in FIG. 14 and FIG. 15.

The system and method of the present invention also solves the problem associated with relative inaccessibility caused by storing large amounts of data on patients with various diseases within a PACS, a clear weakness of the current PACS systems.

In a preferred embodiment, the system and method of the present invention periodically accesses through the use of a WAN, LAN or Internet the native clinical data associated with a PACS system. The periodic access to the native clinical data of the PACS may occur based on a user-request, or a defined times determined by the administrator configuration file associated with the Crawler Index Engine. This process of “raking” data ensures that the copy of a PACS system's raw clinical data remains current and indexed within the Crawler Index Engine for use by the Waypoint Search Engine. The system then decodes, analyzes, indexes and stores the PACS system's native clinical data into a mark-up languages such as HTML, XML, or other similar schema language, wherein the system then waits for a users unstructured query to search the copy. See FIG. 9. This decoding, analyzing, indexing and storing is done via the Crawler Index Engine, more specifically described below. Upon the unstructured query requested by a user as a part of the Waypoint Search Engine interface, the search results are outputted to an end user's output device (i.e. screen, printer or file.)

The portion of the present invention which decodes, analyzes, indexes and stores (i.e. a process of “raking” data) the PACS native clinical data is called the Crawler Index Engine. The Crawler Index Engine gathers clinical data without regard to any user query, free form or otherwise, and prior to any user query. See FIG. 2b; See FIG. 6. The Crawler Index Engine has the responsibility to insure that the index used by the Waypoint Search Engine has the most up to date data available and to organize that data so that the data can be sent to the indexing engine for analysis and storage. See FIG. 3, Index Engine; See FIG. 2C, Index Engine. The Crawler Index Engine can be done run in a single instance or multiple instances of that same engine.

Each process instance of the Crawler Index Engine has a set of configuration data items that is read into the Crawler Index Engine process. See FIG. 5, the administrative configuration file. Once the Crawler Index Engine process has loaded the configuration data of FIG. 5, the Crawler Index Engine process will begin raking the data. The Crawler Index Engine process first looks at a persistent storage area in memory to determine what information was indexed on the last successful crawl. If this information is available, then the Crawler Index Engine process uses that as the stating point for the next crawl of the native clinical database of the PACS. This insures that the index generated by the Crawler Index Engine contains the most current information for use by the Waypoint Search Engine.

The Crawler Index Engine is periodically connected to the native clinical data repositories of the PACS. See FIG. 2A, Data Center. These data repositories or “databases” are defined in the administrative configuration data file of the Crawler Index Engine and include connection and authorization information to connect successfully to each PACS. The administrative configuration data file also includes the frequency of how often each instance of the Crawler Index Engine should “rake” the native clinical database of the PACS. After the connection and authorization is complete, the Crawler Index Engine with request a range of native clinical data from the PACS based on the administrative configuration file. One example of range based raking of the PACS database, is for the Crawler Index Engine to use predefined examination dates and times as the basis of raking the database. See FIG. 4, showing the range based outputs of the Crawler Index Engine, such range based output only seem by administrators of the Crawler Index Engine. The Crawler Index Engine will retrieve the raw clinical data of the PACS within the time range specified by the administrator configuration file. This time span is represented in common units of time i.e. days, hours, minutes etc.

Once the query is constructed to represent the desired time span, the request is sent to the PACS data centers (i.e. databases) for retrieval. This query structure and request method may vary based on what type of clinical PACS databases are involved in the raking. FIG. 3 shows that the Crawler Index Engine will retrieve and parse for review XTML, HTML, RTF, plain text, Microsoft Word and PDF files (Data Documents) so that the Crawler Index Engine may analyze such Data Documents and associated them in the resulting index (see FIG. 2d) for reference with their respective radiological images and other medical imaging formats within the data center (see FIG. 2a). Traditional PACS systems link images and Data Documents via an exam identification number. Once the PACS related Data Documents are accessed by the Crawler Index Engine, such documents are decoded, analyzed, indexed and stored in a searchable XML form in the Crawler Index Engine index. See FIG. 2d. The purpose of decoding the Data Documents is to allow an opportunity to normalize this data prior to the unstructured user search.

After the Data Documents are normalized, the Crawler Index Engine constructs a buffer of the Data Documents that conforms to an XML data schema that will be fed to the search portion of the Crawler Index Engine. See FIG. 2d, Index. Once this buffer construction is completed and queued for indexing, the Crawler Index Engine will hibernate for a configured amount of time, optimally between 3 and 5 minutes. If the Crawler Index Engine instance encounters an error then the process sends a notification and goes into a hibernation cycle which last for a configurable amount of time, optimally between 1 and 2 minutes. After said hibernation cycle is complete the Crawler Index Engine wakes up and attempts to crawl again. During this repetitive process the span of time is continually recalculated to allow the process to move thru the native clinical data of the PACS, including related Data Documents therein. If the Crawler Index Engine process fails to successfully crawl the PACS for a configurable number of times, as defined in the administrator configuration file, then the Crawler Index Engine process replicates itself to a new computer instance of said Crawler Index Engine with the same configuration as its computer Crawler Index Engine ancestor and the computer Crawler Index Engine ancestor terminates.

The end result of the Crawler Index Engine is that the native clinical data of the PACS related Data Document have been reorganized into XML searchable documents, including related metadata, and stored in an index generated by the Crawler Index Engine, see FIG. 2d, for freeform searching as a part of the Waypoint Search Engine.

Unlike FIG. 1, which represents existing structured querying of a PACS system, FIG. 2 shows the current invention with FIGS. 2a, 2b, 2c and 3d representing the Crawler Index Engine method; and FIGS. 2d, 2e, 2f, 2g, and 2h represents the novel unstructured search of the present invention as it relates to a PACS. FIG. 2a represents the PACS system database wherein the raw data of a PACS is stored. FIG. 2c represents the Crawler Index Engine process wherein the Crawler Index Engine collects PACS data from FIG. 2a, see FIG. 2b, and reorganize it into XML searchable documents, such XML searchable documents then retained in a second searchable PACS index. See FIG. 2d. The XML searchable documents contain linkable references, such as examination identification, to the native clinical database of the PACS, including radiological and other medical images.

In FIG. 2h, the current invention requests the user's unstructured free-text query, transforms such query into a structured query language search term, wherein a search is performed on the Crawler Index Engine derived index. See FIG. 2e; See FIG. 2d. The user interface of the Waypoint Search Engine is further shown in FIG. 9 through FIG. 13. The results are returned to the users for subsequent output to the user. See FIG. 2f; see FIG. 2g.

The present invention does not need to index only in XML, but that is the current preferred method. Other markup languages may be used. A markup language is a set of codes that give instructions regarding the structure of a text or how it is to be displayed. For avoidance of doubt, the “Crawler Index Engine” and the “Waypoint Search Engine” are terms used by the inventors to describe different parts of their invention as shown by FIG. 6 and FIG. 7.

### BRIEF DESCRIPTION OF THE DRAWINGS

FIG. 1 is a block diagram of the existing PACS structured query retrieval system;

FIG. 1a is a block diagram representing a PACS users structured query;

FIG. 1b is a block diagram representing the PACS database wherein medical records and images are stored;

FIG. 1c is a block diagram representing the structured query results based on the users input of the PACS database;

FIG. 1d is a block diagram representing the outputting (whether in screen, print, or file) of structured query results for FIG. 1c;

FIG. 2 is a block diagram of the present invention, an unstructured query retrieval system;

FIG. 2a is a block diagram representing the PACS database wherein medical records and images are stored;

FIG. 2b is a block diagram representing the collection process wherein the PACS database wherein medical records and images are processed by the Crawler Index Engine;

FIG. 2c is a block diagram representing the Crawler Index Engine;

FIG. 2d is a block diagram representing the stored output of the Crawler Index Engine, mainly the XML searchable documents;

FIG. 2e is a block diagram representing the unstructured query results based on the users input of the stored output of the Crawler Index Engine;

FIG. 2f is a block diagram representing the outputted unstructured query results based on the users input of the stored output of the Crawler Index Engine;

FIG. 2g is a block diagram representing the media to which the outputted unstructured query results based on the users input of the stored output of the Crawler Index Engine is sent (i.e. display, printer, file, etc.);

FIG. 2h is a block diagram representing the user free text query for use by the Crawler Index Engine is sent;

FIG. 3 is a block diagram representing the Crawler Index Engine process;

FIG. 4 is a block diagram representing the crawler output from the Crawler Index Engine process, as seen by an Administrator, including sleep cycles;

FIG. 5 is a block diagram representing the Crawler Index Engine configuration;

FIG. 6 is a block diagram representing the Crawler Index Engine process portion;

FIG. 7 is a block diagram representing the Search Engine portion of the process;

FIG. 8 is a native structured search screen of a traditional PACS system;

FIG. 9 is the Waypoint Search Engine user interface with query box and metadata search points;

FIG. 10 is the Waypoint Search Engine user interface with query box filled with the term “radiologist” as the search criteria with search results shown on the left hand side;

FIG. 11 is the Waypoint Search Engine user interface with query box filled with the term “radiologist and bone” as the search criteria with search results shown on the left hand side;

FIG. 12 is the Waypoint Search Engine user interface with query box filled with the term “radiologist and bone” as the search criteria and an option to right click on the term “metacarpal”;

FIG. 13 is the Waypoint Search Engine user interface with query box filled with the term “radiologist and bone” as the search criteria and an options to incorporate the term “metacarpal” into the search;

FIG. 14 are the radiological image results from the Waypoint Search Engine user search as shown by a native PACS system; and

FIG. 15 is the radiological image results from the Waypoint Search Engine user search as shown by a native PACS system.

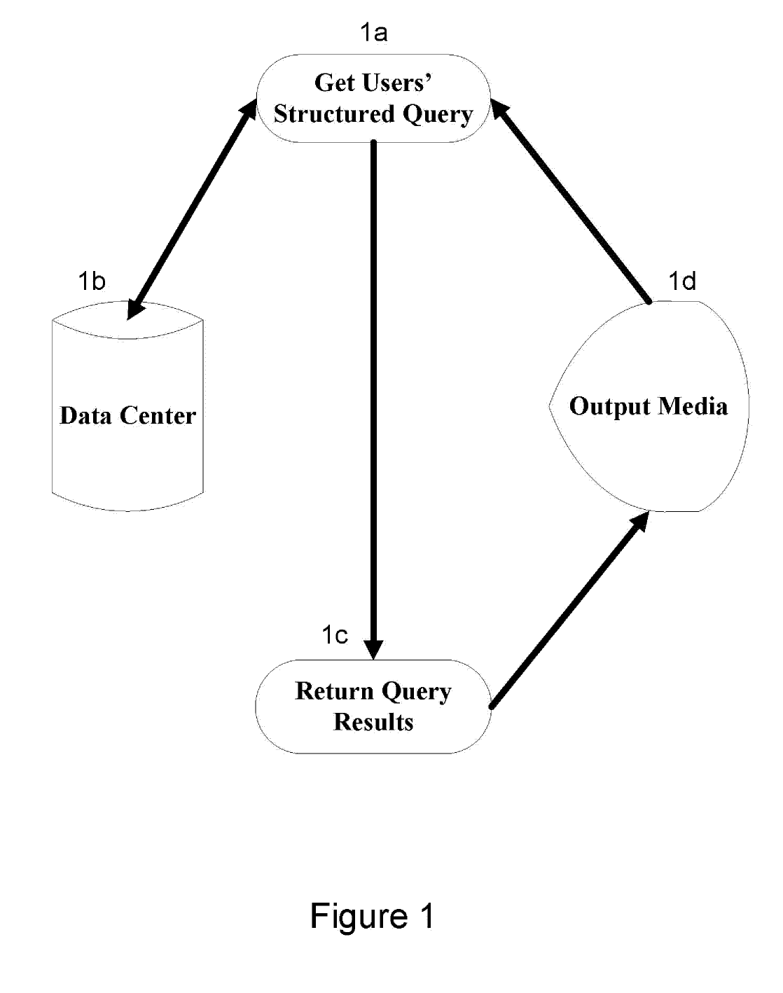

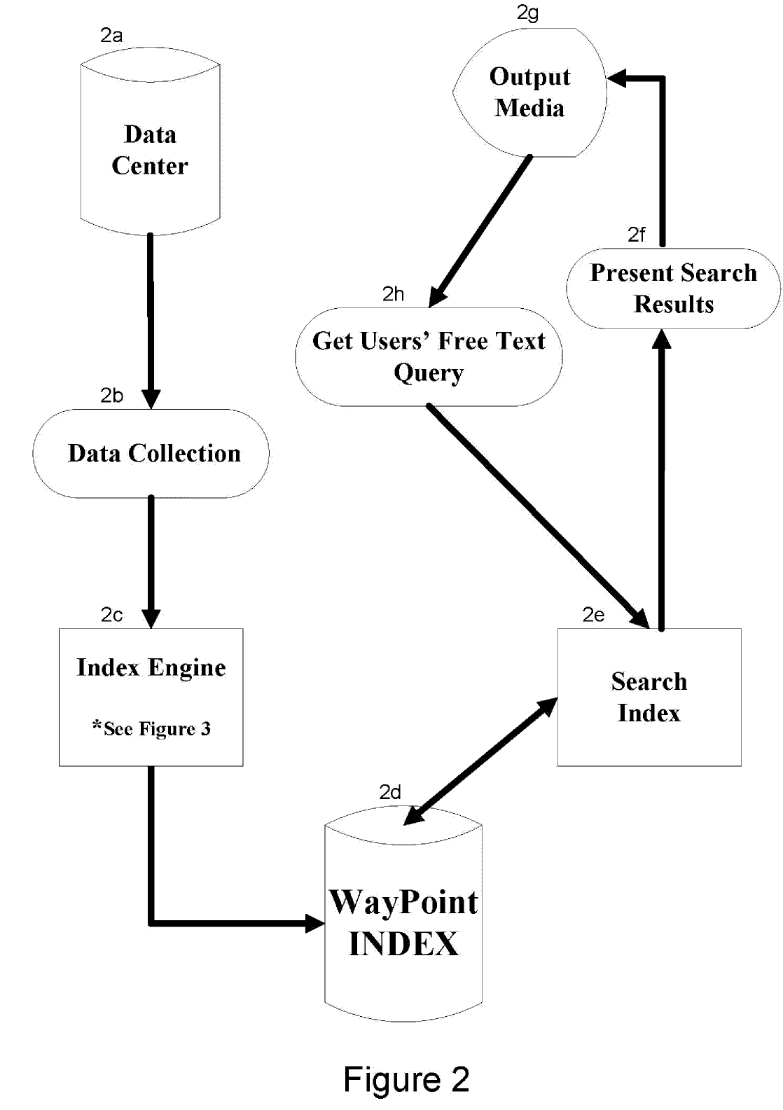

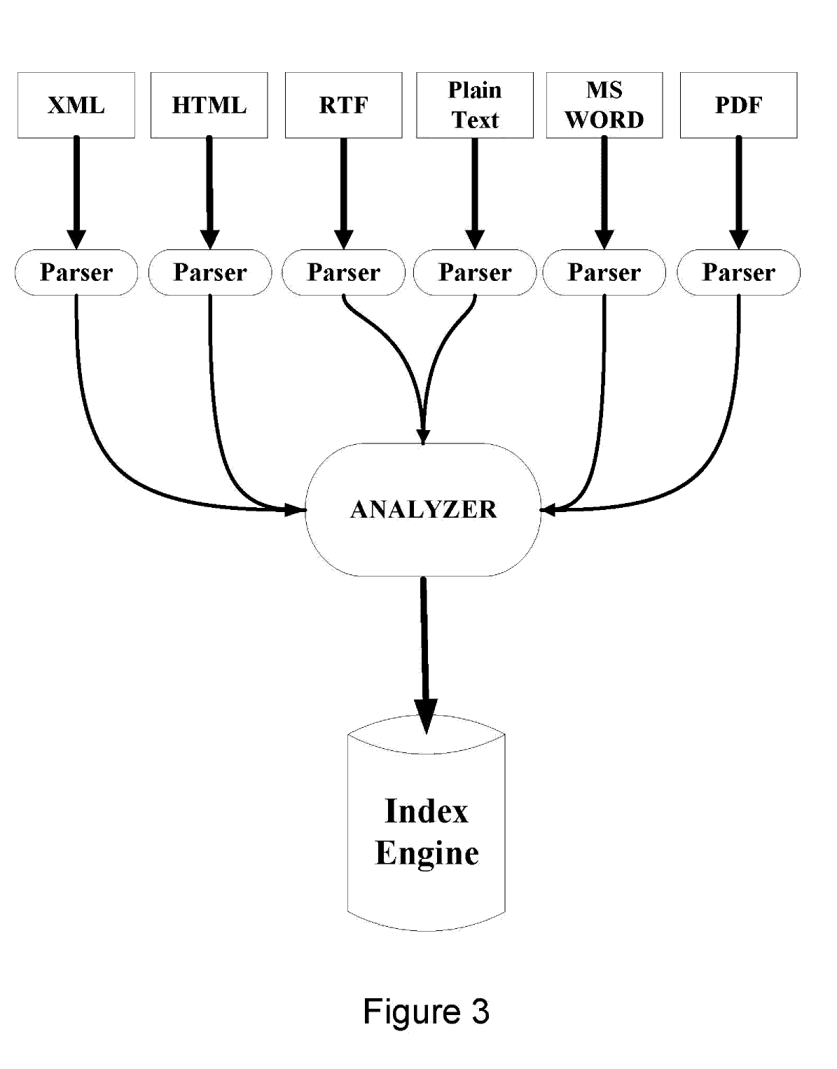

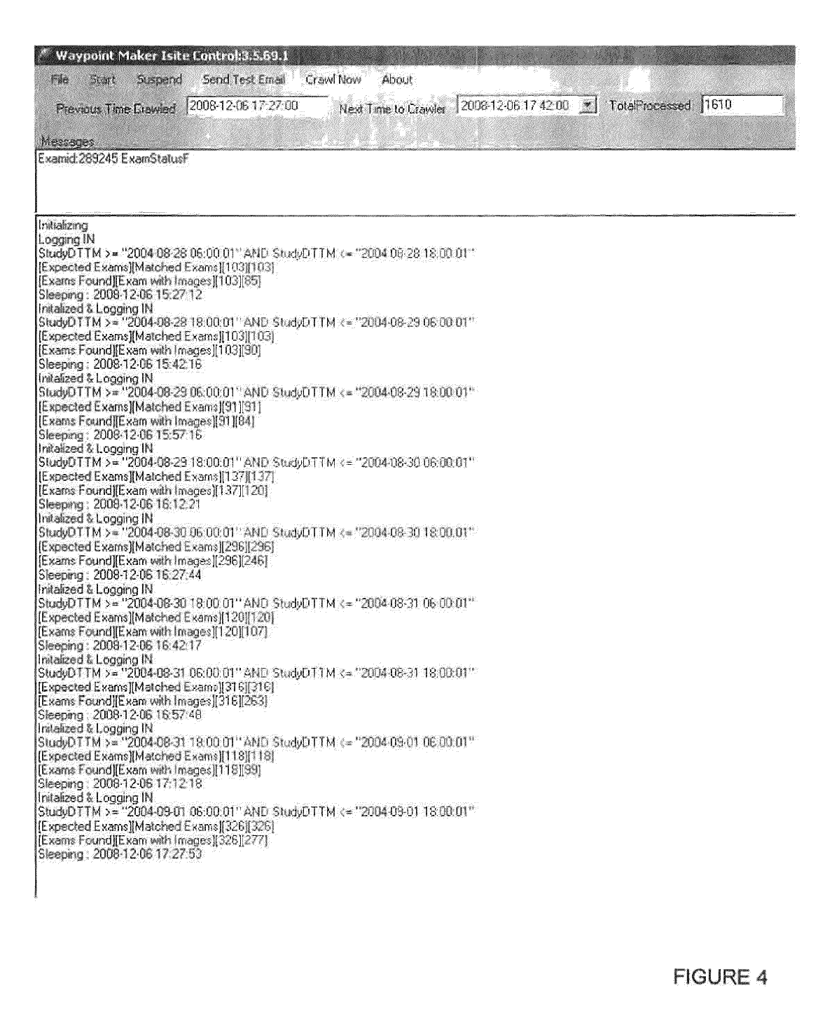

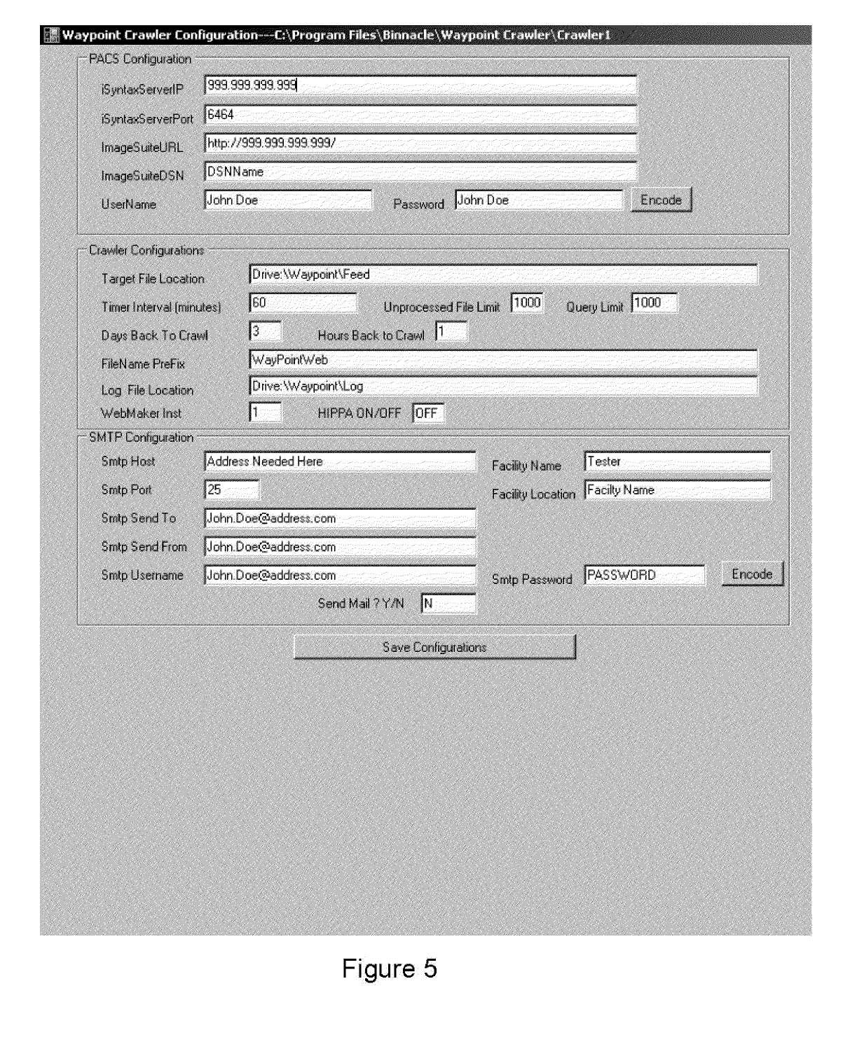

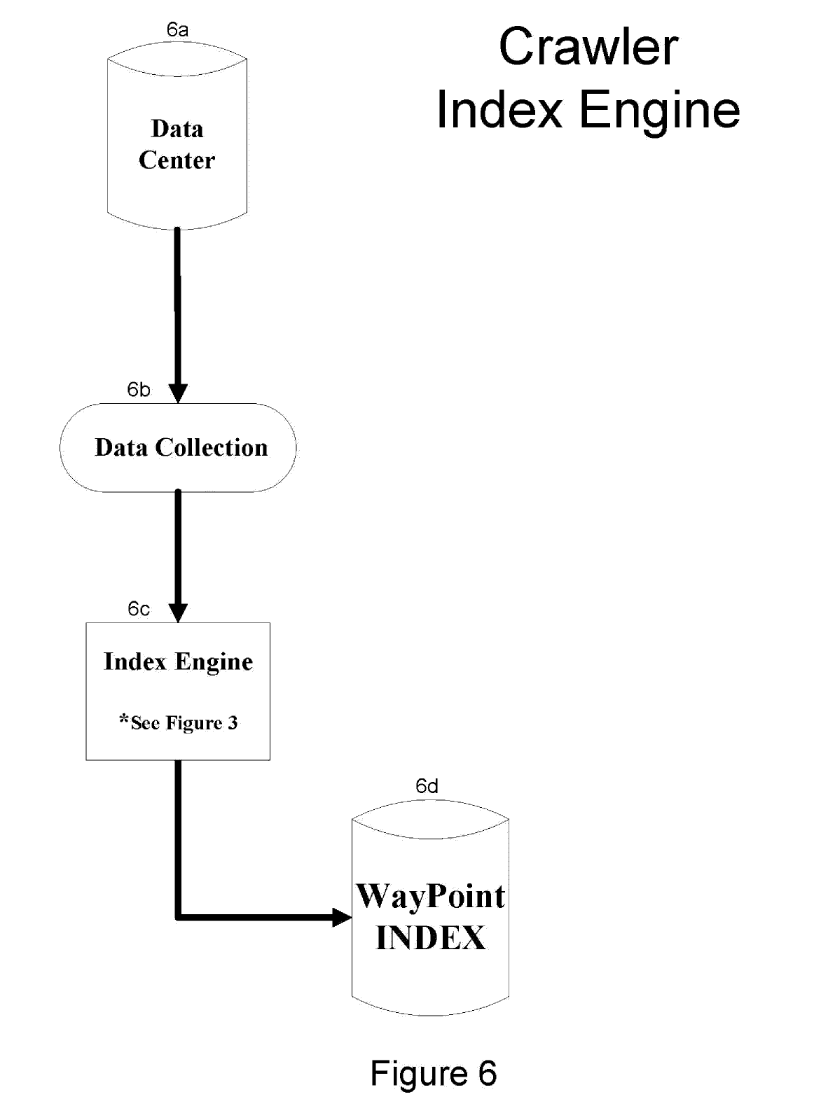

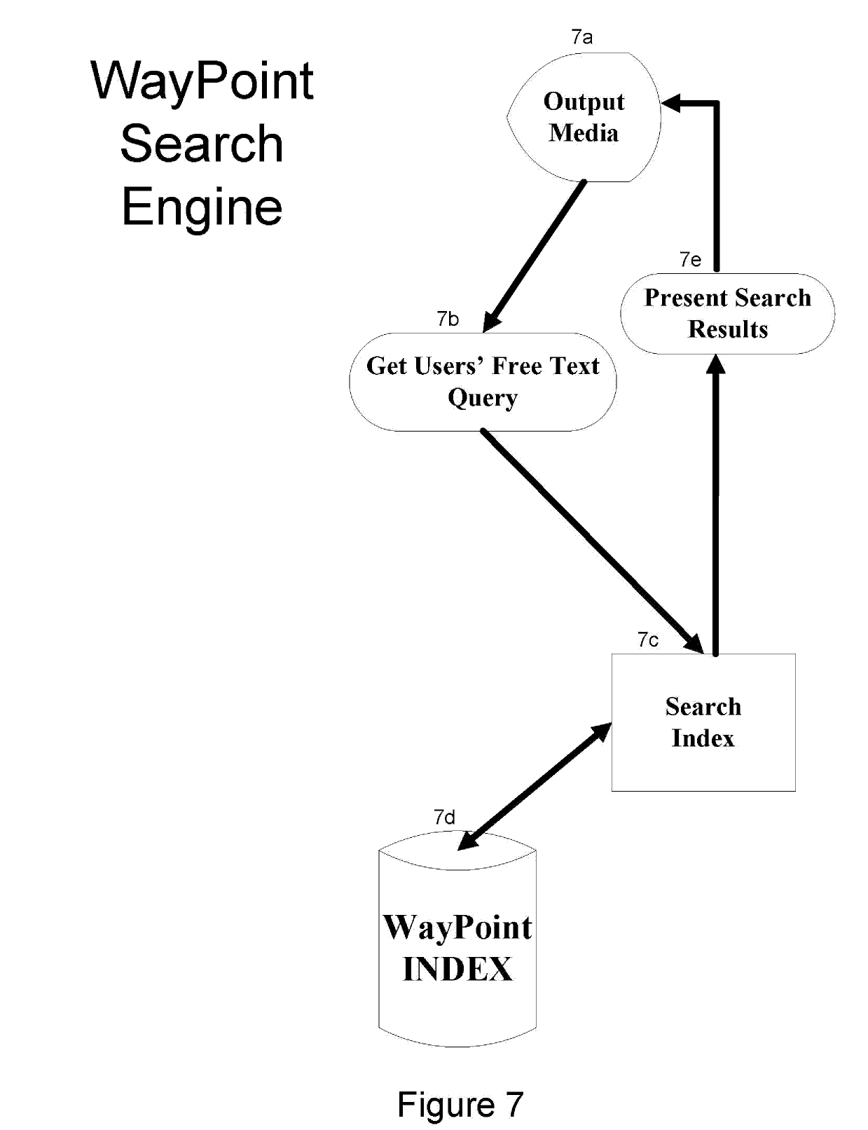

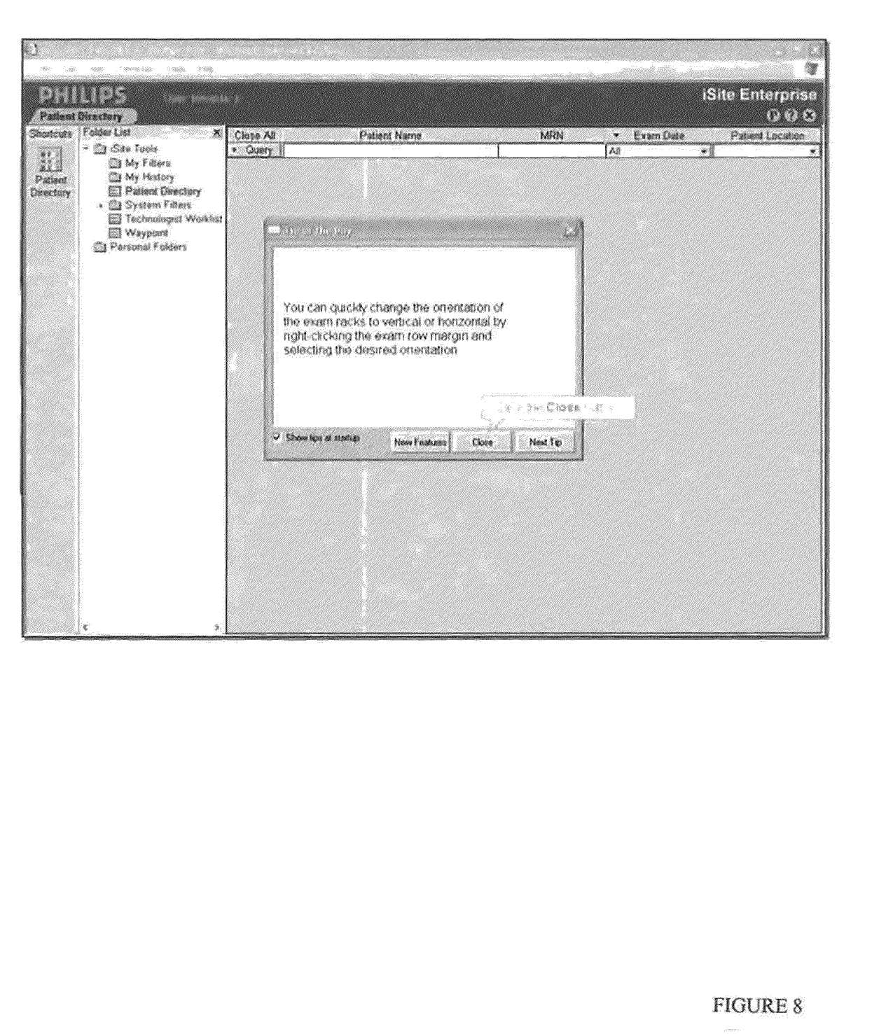

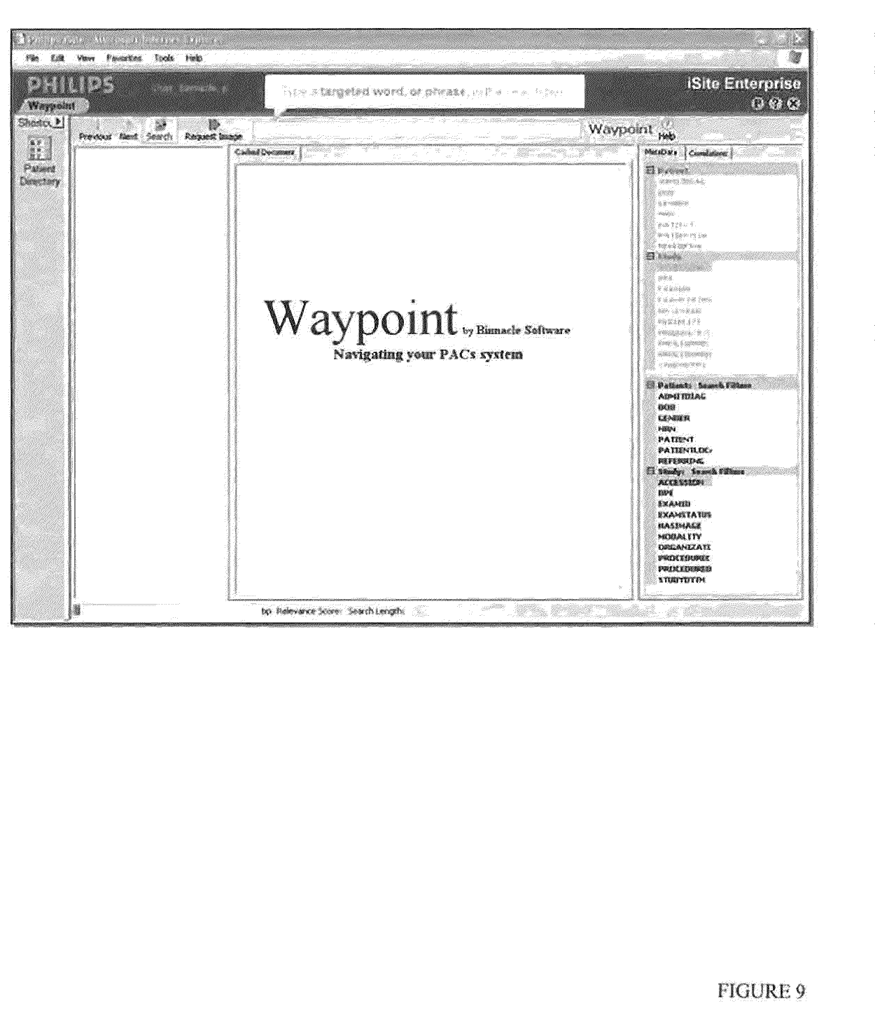

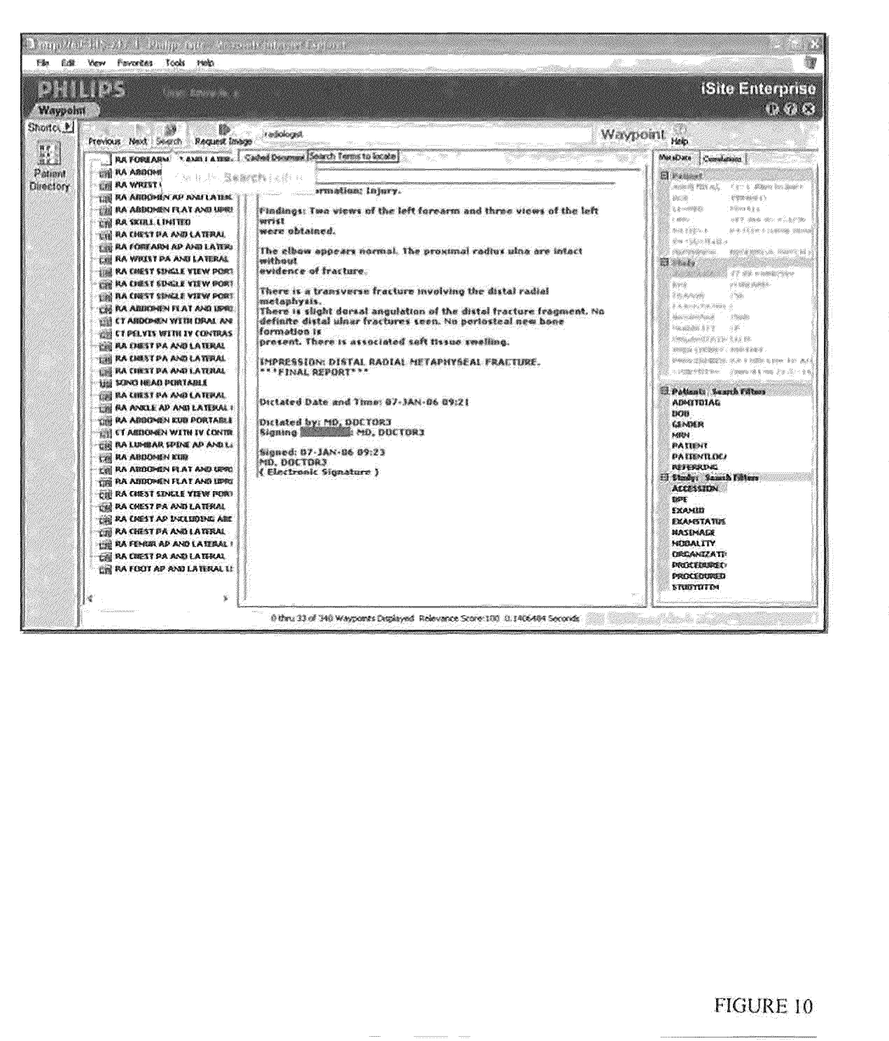

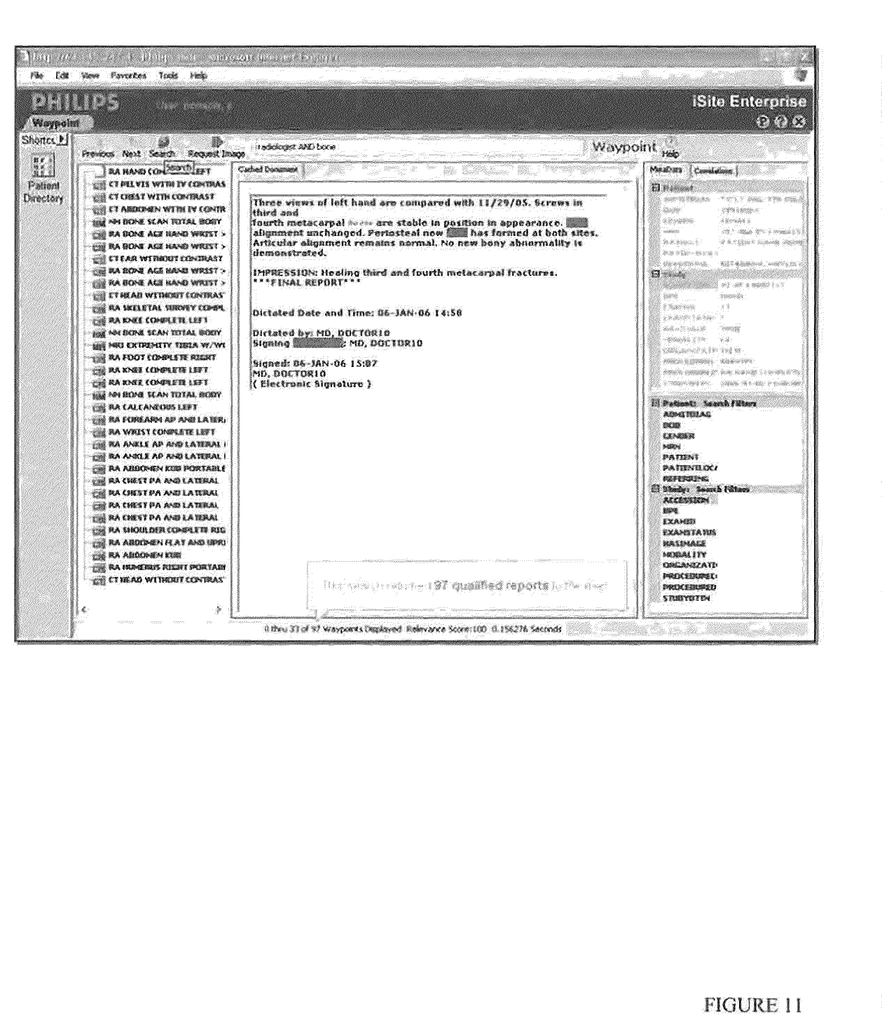

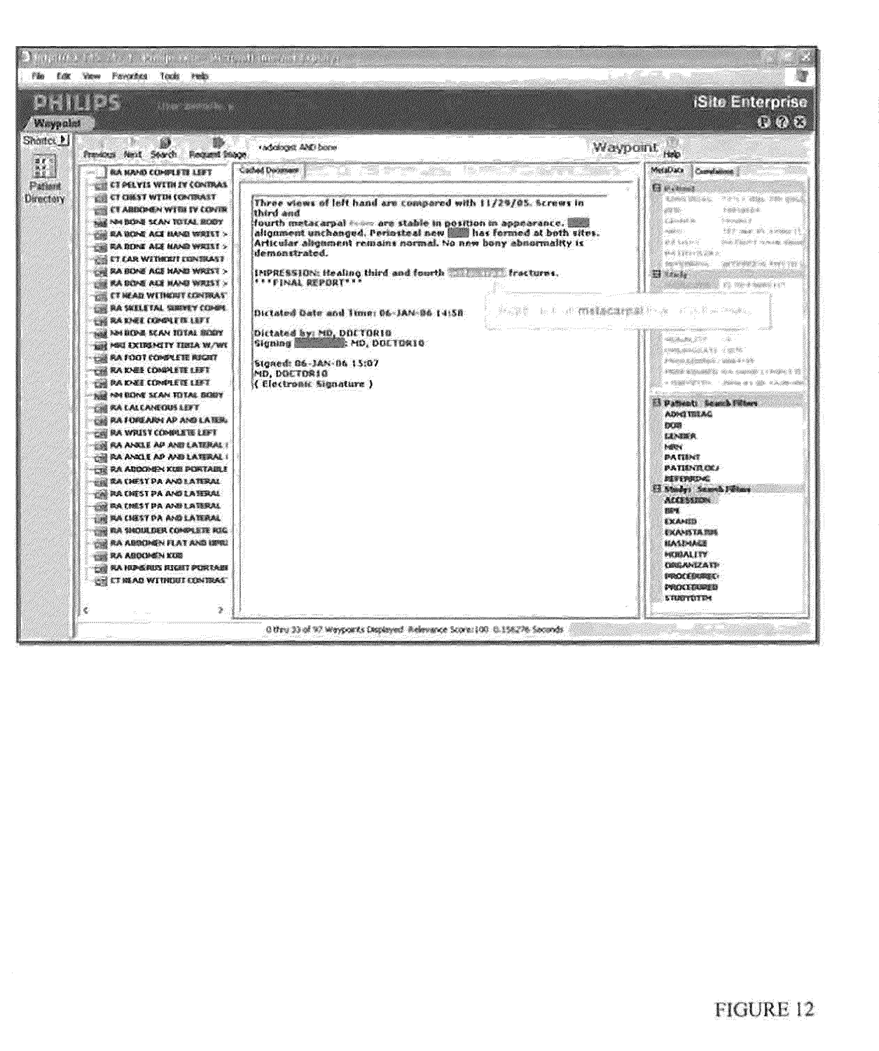

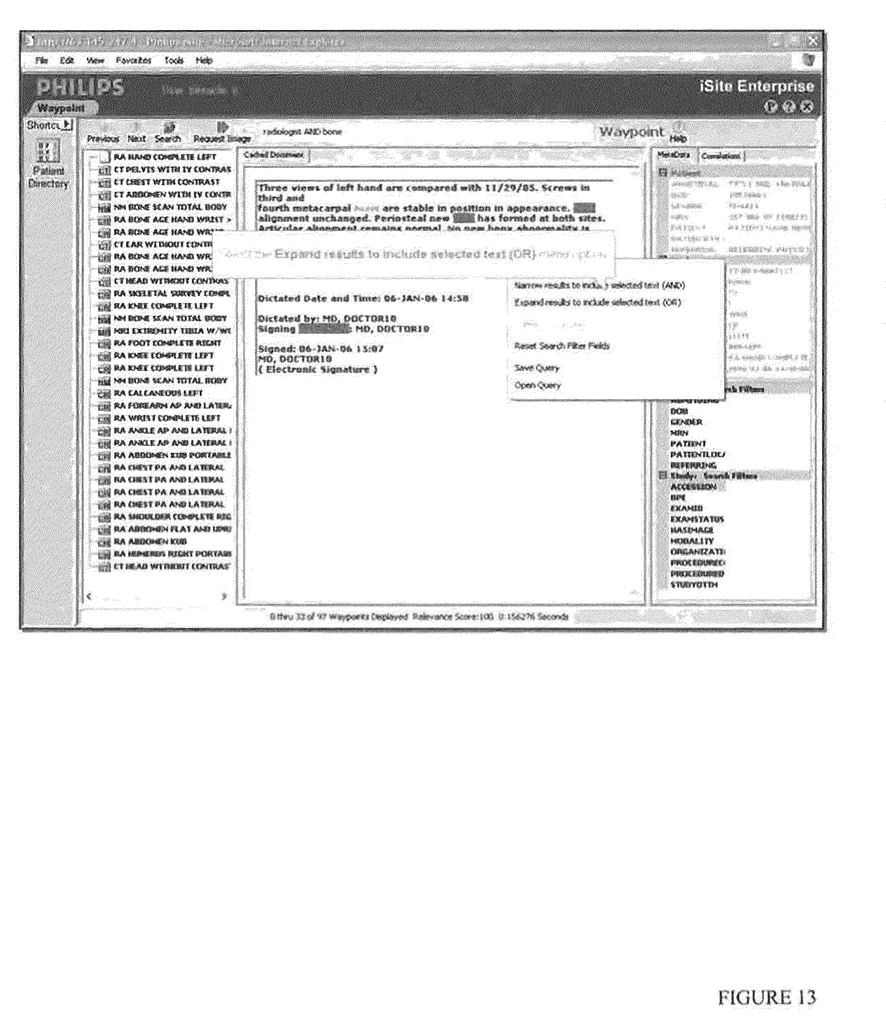

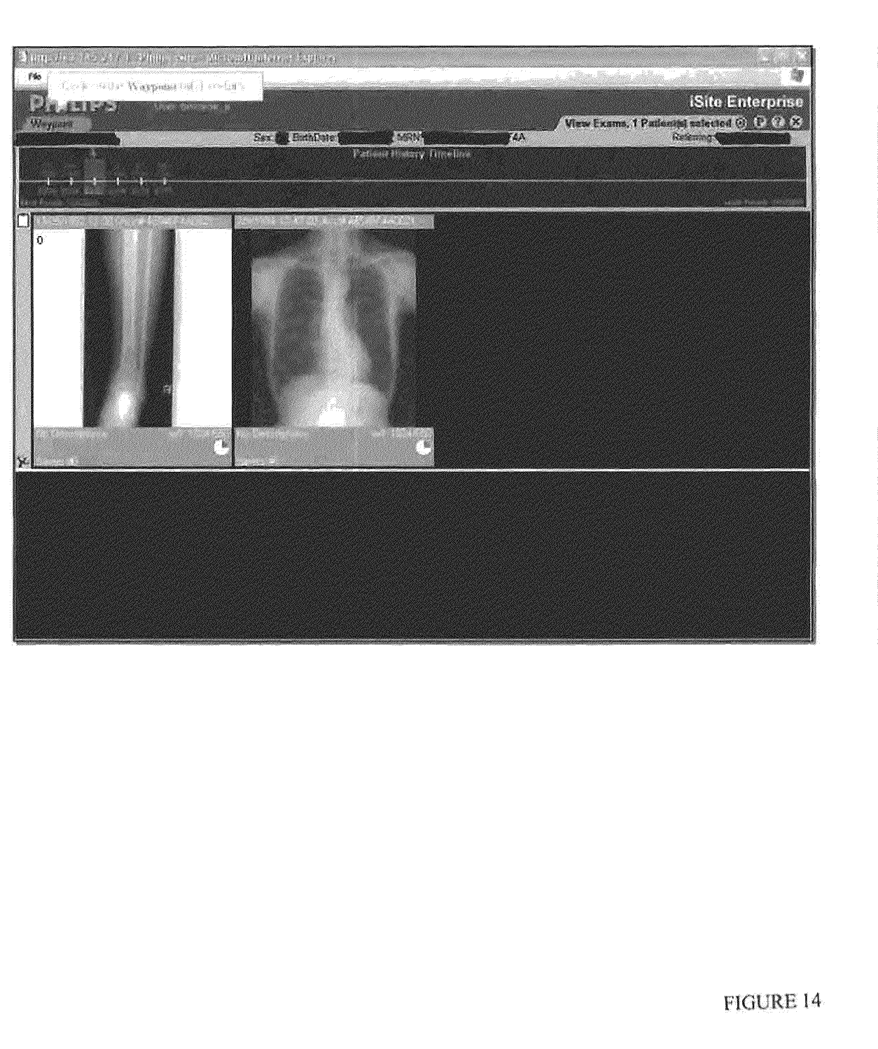

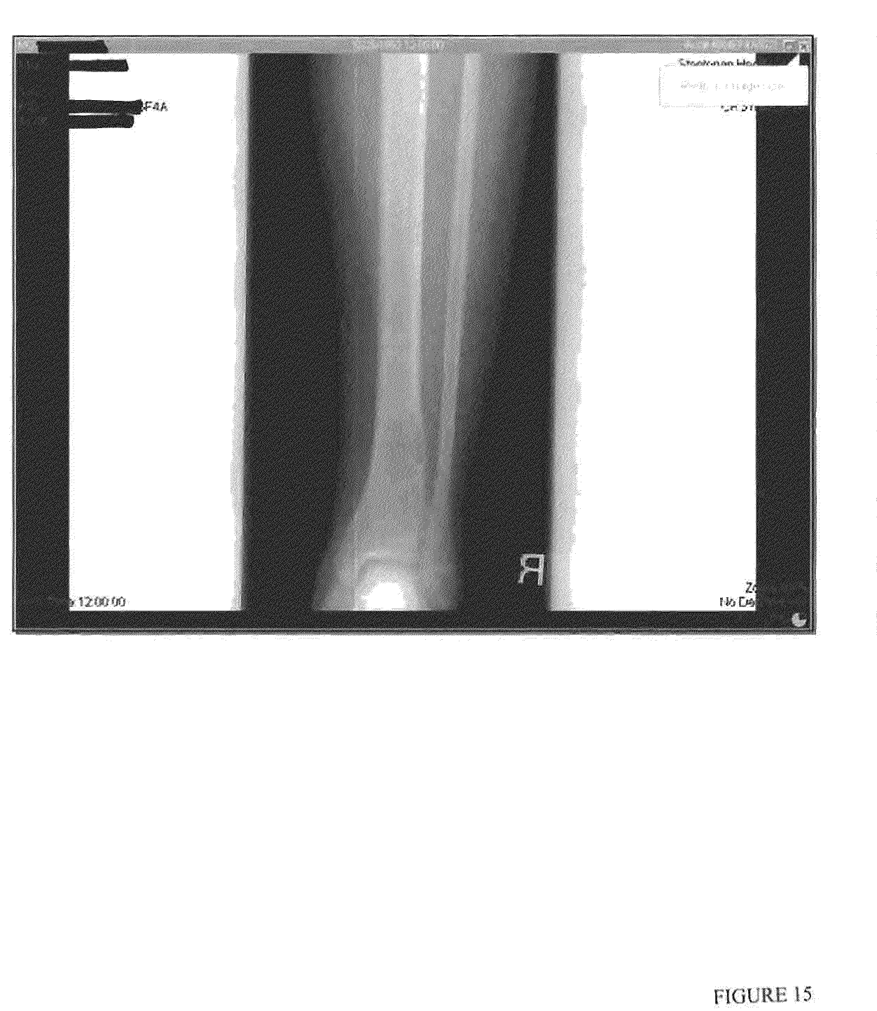

What is claimed is:

1. A computer-implemented method comprising: storing, in a searchable indexed database, (the “Waypoint Index”) content data sets representing searchable medical information from a data center comprises an archive for storing medical images and medical information wherein a plurality of respective patient medical data sets are stored, including the metadata associated with said patient medical data sets, (a “PACS Datacenter”), where each of said patient medical data sets includes medical verbiage from a medical professional; storing said patient medical data sets, including a computer linkable reference to medical images and information of said patient medical data sets, from the PACS Datacenter into the Waypoint Index; indexing the respective patient medical data sets, including metadata therein, on the Waypoint Index into a plurality of markup language documents; a user using a computer connected to the Waypoint Index and PACS Datacenter wherein said user is querying the Waypoint Index; identifying one or more markup language documents within the Waypoint Index using said user search query; generating a search result comprising at least one characterization of at least one relevant markup language document from the Waypoint Index, where at least one characterization of at least one markup language document contains the indexed relevant patient medical data sets and said computer linkable reference to relevant patient medical data sets contained within the PACS Datacenter.

2. The computer implemented method of claim 1, wherein said PACS Datacenter comprises a picture archiving and communications system.

3. The computer implemented method of claim 2, wherein said markup language is selected from the group consisting of XML, HTML, XHTML, GML and SGML.

3. The computer implemented method of claim 3, wherein said computer-implemented method comprises an output device for communicating said markup language documents of said Waypoint Index and PACS Datacenter medical images and medical information to said user for the purposes of displaying, printing, storing and querying.

4. The computer implemented method as defined in claim 3, wherein said user defines one or more search terms for searching said Waypoint Index with said user search query.

5. The computer implemented method as defined in claim 4, further comprising the step of configuring the search according to said user search query.

6. The computer implemented method as defined in claim 5, further comprising the step of searching the Waypoint Index with said user search query and returning a search result.

7. The computer implemented method as defined in claim 6, wherein said search result comprises content found within the markup language documents of the Waypoint Index with said computer linkable reference to said relevant patient medical data sets of the PACS Datacenter.
